(19) United States
(12) Patent Application Publication
(10) Pub. No.: US 2016/0034661 A1
(43) Pub. Date: Feb. 4, 2016

(54) ACCESSING CONTENT BASED ON A HEALTH ASSESSMENT

(71) Applicants: Shailesh Dinkar Govande, Milpitas, CA (US); Madhura Pravin Tipnis, Milpitas, CA (US)

(72) Inventors: Shailesh Dinkar Govande, Milpitas, CA (US); Madhura Pravin Tipnis, Milpitas, CA (US)

(21) Appl. No.: 14/445,630

(22) Filed: Jul. 29, 2014

(51) Int. Cl. G06F 19/00

(52) U.S. Cl. CPC G06F 19/3431

(57) ABSTRACT

Systems and methods directed to accessing content based on a health assessment are described herein. A health indicator of a user may be received from a device associated with the user. A health assessment is performed based on the received health indicator of the user. A determination that the received health indicator of the user indicates at least a pre-defined condition of health is performed. Content that corresponds to the performed health assessment is accessed. The accessed content is then presented to the device associated with the user.

### TECHNICAL FIELD

The subject matter disclosed herein generally relates to the processing of data. Specifically, the present disclosure addresses systems and methods to access content based on a health assessment.

### BACKGROUND

Mobile devices may enable users to track their physical activity. In particular, the mobile devices may include sensors that are used for tracking data regarding the physical activity of the users.

### BRIEF DESCRIPTION OF THE DRAWINGS

Some embodiments are illustrated by way of example and not limitation in the figures of the accompanying drawings.

FIG. 1 is a network diagram illustrating a network environment suitable for accessing content based on a health assessment, according to some example embodiments.

FIG. 2 is a block diagram illustrating components of a server machine suitable, according to some example embodiments.

FIG. 3 is a block diagram illustrating an example user interface that includes health indicators of a user, according to some example embodiments.

FIG. 4 is a block diagram illustrating an example user interface of content that corresponds to a health assessment, according to some example embodiments.

FIG. 5 is a block diagram illustrating an example user interface of content that corresponds to a health assessment, according to some example embodiments.

FIG. 6-8 are flowcharts illustrating operations of a server machine in performing a method of presenting content that corresponds to a health assessment to a device associated with a user, according to some example embodiments.

FIG. 9 is a block diagram illustrating components of a machine, according to some example embodiments, able to read instructions from a machine-readable medium and perform any one or more of the methodologies discussed herein.

### DETAILED DESCRIPTION

Example methods and systems are directed to accessing content based on a health assessment. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Physical activity of a user may be tracked via a mobile device that is associated with the user. For instance, the user may wear the device such that the mobile device is in physical contact with the user. Once worn by the user, the mobile device may utilize sensors housed within the device in order to track the physical activity of the user. Physical activity may include a user's: movement, sleep, conversation, consumption, and the like. For example, the mobile device may be worn by a user that is jogging up a mountain. As another example, the mobile device may be worn by a user that is sleeping. The mobile device may generate a health indicator of the user that corresponds to the physical activity of the user tracked by the mobile device. Moreover, a server may receive the health indicator from the mobile device associated with the user. The server may perform a health assessment of the user based on the received health indicator. Thereafter, the server may control access to content based on the health assessment of the user. For instance, the server may determine that the user meets certain health criteria based on the received health indicator and prior to allowing access to the content. The server may also recommend item pages of items that are relevant to the user based on the health assessment of the user. The server may also provide alerts to other devices associated with the user based on the health assessment of the user. The server may also restrict access to content based on the health assessment of the user.

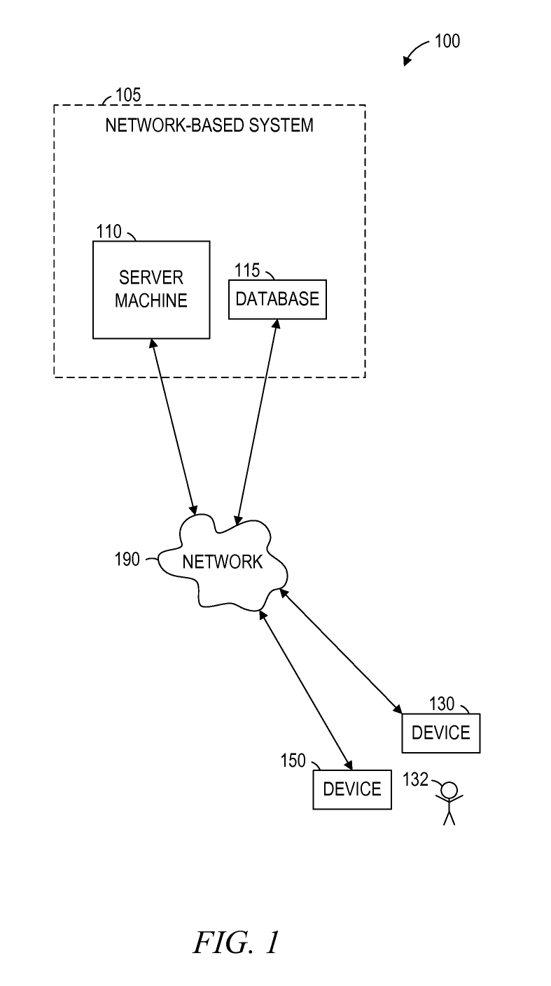

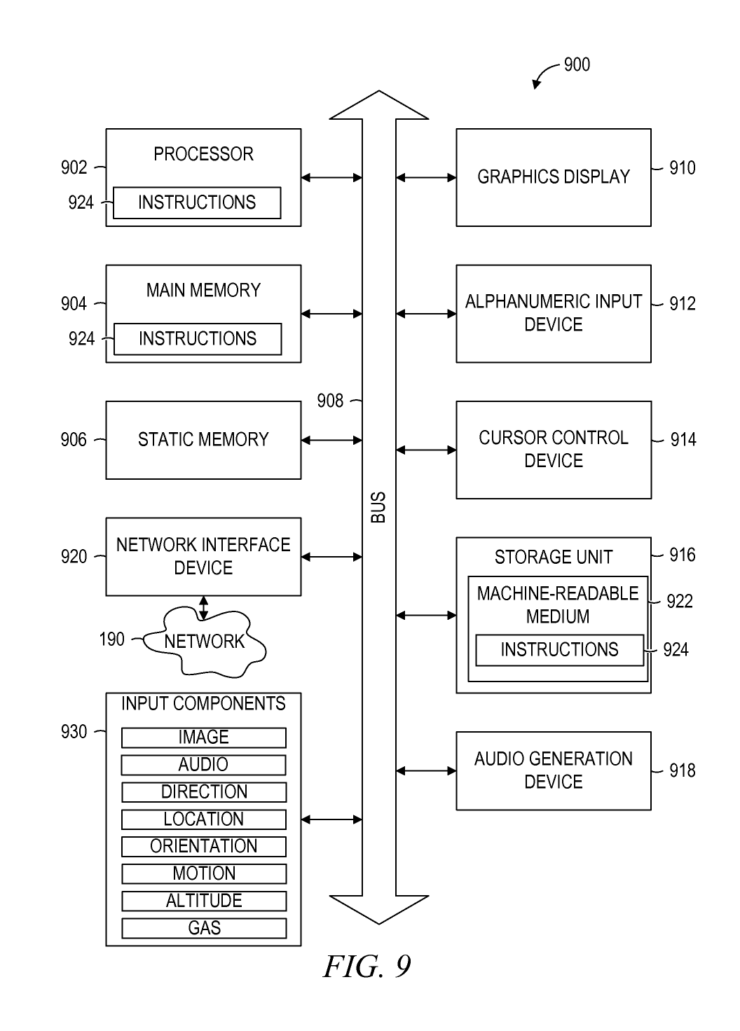

FIG. 1 is a network diagram illustrating a network environment 100 suitable for accessing content based on a health assessment, according to some example embodiments. The network environment 100 includes a server machine 110, a database 115, and devices 130 and 150, all communicatively coupled to each other via a network 190. The server machine 110 may form all or part of a network-based system 105 (e.g., a cloud-based server system configured to provide one or more services to the devices 130 and 150). The server machine 110 and the devices 130 and 150 may each be implemented in a computer system, in whole or in part, as described below with respect to FIG. 9.

Also shown in FIG. 1 is user 132. The user 132 may be a human user (e.g., a human being), a machine user (e.g., a computer configured by a software program to interact with the device 130 or the device 150), or any suitable combination thereof (e.g., a human assisted by a machine or a machine supervised by a human). The user 132 is not part of the network environment 100, but is associated with devices 130 and 150 and may be a user of the device 130 and the device 150. For example, the device 130 may be a desktop computer, a vehicle computer, a tablet computer, a navigational device, a portable media device, a smartphone, or a wearable device (e.g., a smart watch or smart glasses) belonging to the user 132. Moreover, the device 150 may be a desktop computer, a vehicle computer, a tablet computer, a navigational device, a portable media device, a smartphone, or a wearable device (e.g., a smart watch or smart glasses) belonging to the user 132.

In various example embodiments, the device 130 may be used to track the physical activity of the user 132. Moreover, a health indicator that corresponds to the tracked physical activity may be generated by the device 130. The server may receive the health indicator from the device 130. The server may perform a health assessment of the user based on the received health indicator. Thereafter, the server may control access to content based on the health assessment of the user. The server may also generate an alert based on the health assessment and send the alert to the device 150. For example, if the user is intoxicated, the server may send the alert to the device 150 to temporarily disable functionality of the device 150.

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 9. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

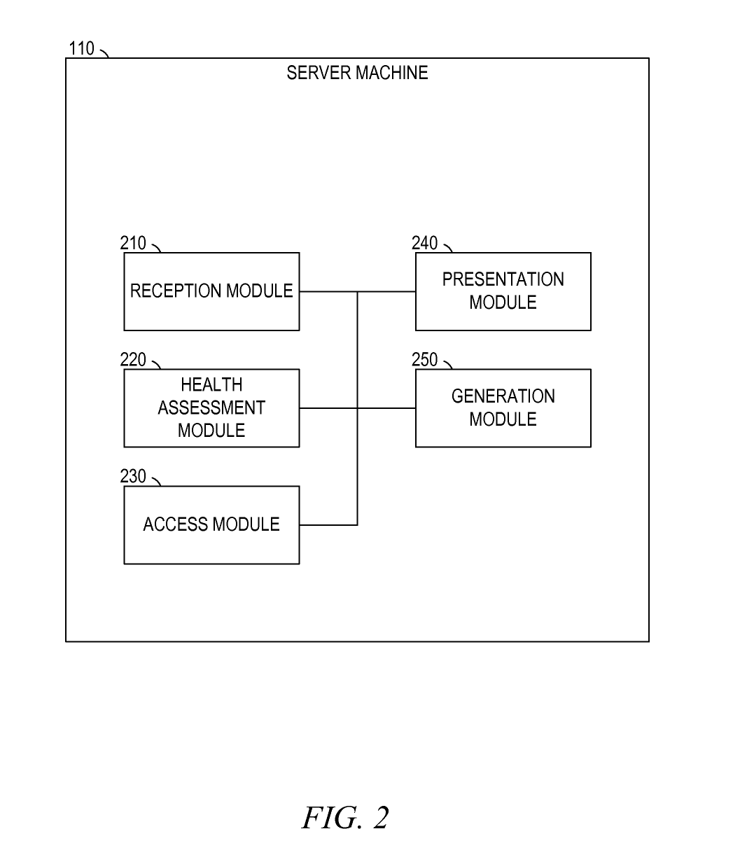

FIG. 2 is a block diagram illustrating components of the server machine 110, according to some example embodiments. The server machine 110 is shown as including a reception module 210, a health assessment module 220, an access module 230, a presentation module 240, and a generation module 250, all configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In various example embodiments, the reception module 210 is configured to receive a health indicator of a user. The health indicator of the user may be received from a device associated with the user. Moreover, the device associated with the user may be physically coupled to the user. The health indicator provides information regarding a health of the user. For instance, the health indicator may describe certain health conditions exhibited by the user. In some instances, the health indicator of the user may be a value or metric used to indicate the health of the user. In various example embodiments, the health indicator of the user corresponds to a physical activity performed by the user. The physical activity performed by with the user may include actions such as walking, running, sleeping, social interaction, consumption of food, and the like. As an example, the health indicator of the user may be a value that is correlated with the amount of physical activity performed by the user. Therefore, a higher value may be assigned to a user that has performed more physical activity than a user with a lower value. For example, the health indicator of the user may be a number of miles run by the user, a number of laps swam by the user, a number of calories burned, and the like. In some instances, the health indicator of the user corresponds to an intensity level associated with the physical activity performed by the user. Other examples of health indicators may include body temperature, heart rate, blood sugar, blood alcohol content, blood pressure, level of anxiety, volume of sweat, amount of sleep, weight, and the like. Moreover, each of these health indicators may correspond to the physical activity performed by the user. For instance, the body temperature may correlate with a distance that the user has run. As another example, the blood alcohol content may correlate with how much alcohol is consumed by the user.

In various example embodiments, the reception module 210 is further configured to receive a pre-defined condition of health from the device associated with the user. Alternatively, the pre-defined condition of health may be automatically generated by the generation module 250. The pre-defined condition of health is further explained below.

In various example embodiments, the reception module 210 is further configured to receive a request to view content. The request may be received from the device associated with the user. In various example embodiments, the reception module 210 is further configured to receive a request to view further content. Moreover, both the content and the further content may be featured on a single web page. Alternatively, a first web page may feature the content that includes a link to a second web page that features the further content. In various example embodiments, the reception module 210 is further configured to receive data that indicates a location of the device associated with the user. The reception module 210 may receive the data from the device associated with the user.

In various example embodiments, the health assessment module 220 is configured to perform a health assessment based on the health indicator received at the reception module 210. The health assessment may identify specific health characteristics that are attributable to the user. Moreover, the health assessment may correspond to the health indicator of the user. For example, the health assessment module 220 may determine that the user is anxious when a user's blood pressure exceeds a certain amount. As another example, the health assessment module 220 may determine that the user is intoxicated when the blood alcohol content of the user exceeds a certain amount. In some instances, the health assessment may be represented by the health indicator of the user or may simply be the health indicator of the user. In various example embodiments, the health assessment module 220 is further configured to determine that the received health indicator of the user indicates at least the pre-defined condition of health. The pre-defined condition of health may prescribe certain health conditions that are required by the user before allowing access to view the content. In some instances, the pre-defined condition of health may be represented as a value. For example, the pre-defined condition of health may require the user to have at least 8 hours of sleep. Moreover, the pre-defined condition of health may represent a minimum amount of physical activity required to be performed by the user. As an example, the pre-defined condition of health may require the user run at least 3 miles. As another example, the pre-defined condition of health may require the user to have burned at least 1000 calories. Accordingly, the health assessment module 220 may be further configured to compare a value that corresponds to the health indicator with a value that corresponds to the pre-defined condition of health.

In various example embodiments, the health assessment module 220 is further configured to perform the health assessment based on the data that indicates the location of the device associated with the user. As an example, if the data indicates that the user is located near a fitness center, the health assessment module 220 may determine that the user is currently exercising and is reasonably fit. In some instances, the data that indicates that location of the device may be used by the health assessment module 220 in combination with the health indicators of the user to perform the health assessment. For instance, if the data indicates that the user is located near an establishment that serves alcohol and the user's blood alcohol content reaches a certain level, the health assessment module 220 may determine that the user is intoxicated.

In various example embodiments, the access module 230 is configured to access content that corresponds to the health assessment performed by the health assessment module 220. In some instances, the content may correspond to the health assessment and may include information that is related to the health assessment performed by the health assessment module 220. In various example embodiments, the access module 230 is further configured to access the content based on determination by the health assessment module 220 that the received health indicator of the user indicates at least the pre-defined condition of health. Therefore, access to the content may depend on the determination performed by the health assessment module 220. In various example embodiments, the content accessed by the access module 230 includes web pages frequently browsed by the user (e.g., Facebook, bookmarked pages, and recently visited pages). In various example embodiments, the access module 230 is further configured to access the content in response to receipt of the request to view the content.

In various example embodiments, the content accessed by the access module 230 includes a reward that corresponds to the performed health assessment. For instance, the reward may be achieved after the user completes certain physical activities. In some instances, the reward may have monetary value and may be used by the user in exchange for other items of value. In some instances, the reward can be status indicators. For example, if the user successfully completes a marathon, a badge may be issued to the user in order to mark the achievement.

In various example embodiments, the access module 230 is further configured to determine that an item has item characteristics that correspond to the health assessment of the user. As stated previously, the health assessment of the user may identify specific health characteristics that are attributable to the user. The access module 230 may be further configured to determine that the item characteristics of the item match with the specific health characteristics attributable to the user. For example, an item with sleep-aiding properties may be determined by the access module 230 to correspond to a user that is determined to be sleep deprived. As another example, a pair of running shoes may be determined by the access module 230 to correspond to a user that is determined to be fit. In various example embodiments, the access module 230 is further configured to access an item page of the item that has the item characteristics that correspond to the health assessment of the user. The item page may include a description of the item, a picture of the item, a control operable to purchase the item, and the like. In various example embodiments, the access module 230 is further configured to access a link for the item page of the item. The link may be selectable by the device associated with the user in order to cause the item page to be displayed on the device.

In various example embodiments, the access module 230 is further configured to determine that further content is incompatible with the health assessment of the user. The access module 230 may access the further content in response to receipt of the request to view the further content. As stated previously, the health assessment of the user may identify specific health characteristics that are attributable to the user. In various example embodiments, the access module 230 is further configured to detect that the further content includes information that is dangerous or unsafe to a user based on the performed health assessment. As an example, a user with anxiety issues may react poorly to news regarding a natural disaster. As another example, the further content may be news that is particularly shocking to the user given the user's health assessment. In various example embodiments, the access module 230 is further configured to restrict access to the further content based on the determining that the further content is incompatible with the performed health assessment. The access module 230 may censor the further content. For example, the access module 230 may restrict access to menus of foods that are high in sodium to a user with high blood pressure. As an example, the access module 230 may be further configured to restrict access to professional or business content to a user that is currently intoxicated or has blood alcohol content above a certain amount. In some instances, the further content and the content are both featured on a single web page. In other words, the single web page may include information that is incompatible with the health assessment of the user as well as information that corresponds to the health assessment of the user. Alternatively, a first web page may feature the content that includes a link to a second web page that features the further content.

In various example embodiments, the presentation module 240 is configured to present the accessed content to the device associated with the user. The accessed content may be displayed on the device associated with the user. In various example embodiments, the presentation module 240 is further configured to send an alert to a further device associated with the user. The alert may be used to disable functionality of the further device associated with the user. For instance, if the user is intoxicated, the alert may be used to disable functionality of the further device associated with the user. The alert may be generated by the generation module 250 as further explained below.

In various example embodiments, the generation module 250 is configured to generate an alert based on the performed health assessment. The alert may be used to provide for the safety of the user. For instance, the generation module 250 may generate an alert that indicates that the user is currently intoxicated based on the performed health assessment. As another example, the generation module 250 may generate an alert that indicates that the user is sleep deprived based on the performed health assessment.

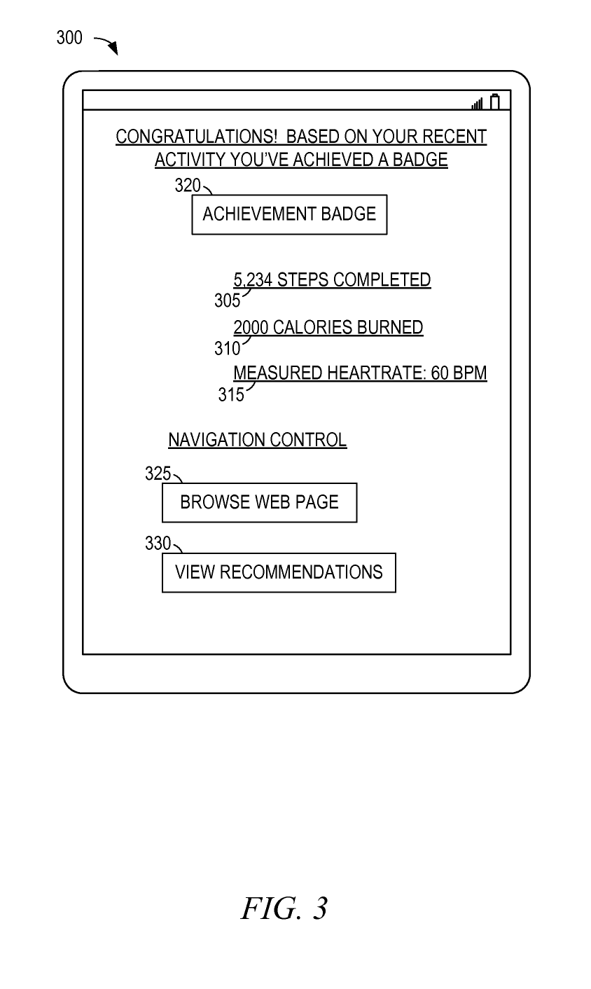

FIG. 3 is a block diagram illustrating an example user interface 300 that includes the health indicators of the user, according to some example embodiments. The health indicators may include a first health indicator 305, a second health indicator 310, and a third health indicator 315. Moreover, each of the health indicators may be displayed within a portion of the user interface 300. The user interface 300 may be displayed on a device associated with the user. Moreover, the health indicators may correspond to physical activity performed by the user. Further, the user interface 300 may display an achievement 320 to award the user based on the first health indicator 305, the second health indicator 310, or the third health indicator 315. The user interface 300 further includes a first button 325 and a second button 330. The first button 325 may be operable to send a request to the server machine 110 to view a web page. The second button 330 may be operable to send a request to the server machine 110 to view recommendations.

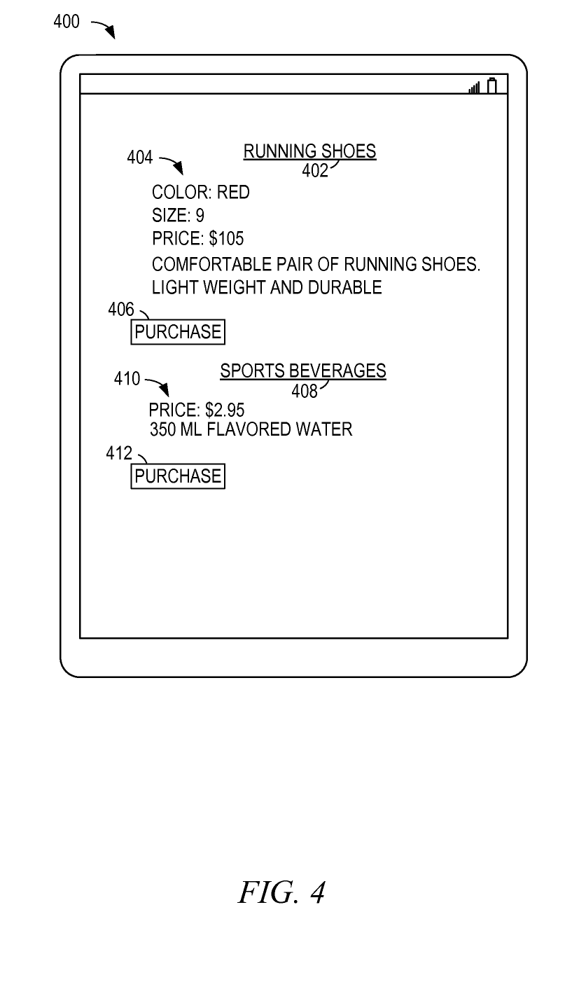

FIG. 4 is a block diagram illustrating an example user interface 400 of content that corresponds to a health assessment, according to some example embodiments. The user interface 400 may be displayed on a device associated with the user. Moreover, the user interface 400 may be displayed in response to operation of the second button 330 of FIG. 3. The user interface 400 may include a recommendation for a pair of running shoes 402. Moreover, the recommendation may include a description 404 of the running shoes 402. The user interface 400 may further include a control 406 operable to purchase the running shoes 402. The recommendation may correspond to the health assessment performed by the health assessment module 220. The health assessment module 220 may perform the health assessment based on health indicators of the user. For instance, the health assessment module 220 may determine the user to be a fit based on any of the first health indicator 305, the second health indicator 310, or the third health indicator 315 of FIG. 3. Also included in the user interface 400 is a recommendation for sports beverages 408 which also corresponds to the health assessment performed by the health assessment module 220. Moreover, the recommendation includes a description 410 of the sports beverages 408 and a control 412 operable to purchase the sports beverages 408. Each of the recommendations may be presented to the user within the user interface 400 by the presentation module 240.

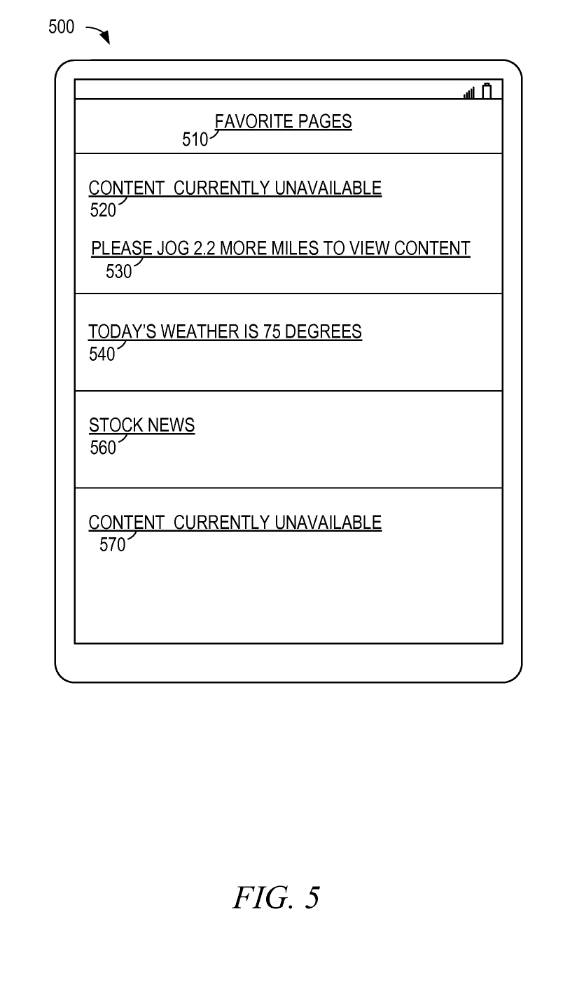

FIG. 5 is a block diagram illustrating an example user interface 500 of content that corresponds to a health assessment, according to some example embodiments. The user interface 500 may be displayed on a device associated with the user. Moreover, the user interface 400 may be displayed in response to operation of the first button 320 of FIG. 3. The user interface 500 may display favorite pages 510 of the user. The user interface 500 may include content 520 that is restricted by the access module 230. The access module 230 may restrict access to the content 520 based on the health assessment of the user. The content 520 may be restricted by the access module 230 for various reasons. For instance, the health assessment module 220 may determine that the health indicators of the user do not meet certain pre-defined health conditions and therefore the access module 230 may not access the content 520. The user interface 500 may further include a description 530 which informs the user of additional physical activity required to meet the pre-defined health conditions. Also included in the user interface 500 are content 540 and content 560 that are not restricted by the access module 230. The user interface 500 may include further content 570 that is restricted by the access module 230. The further content 570 may be restricted by the access module 230 for various reasons. For instance, the content 570 may be incompatible with the health assessment of the user. As an example, the content 570 may pertain to news that is particularly shocking and harmful to the user given the health assessment of the user.

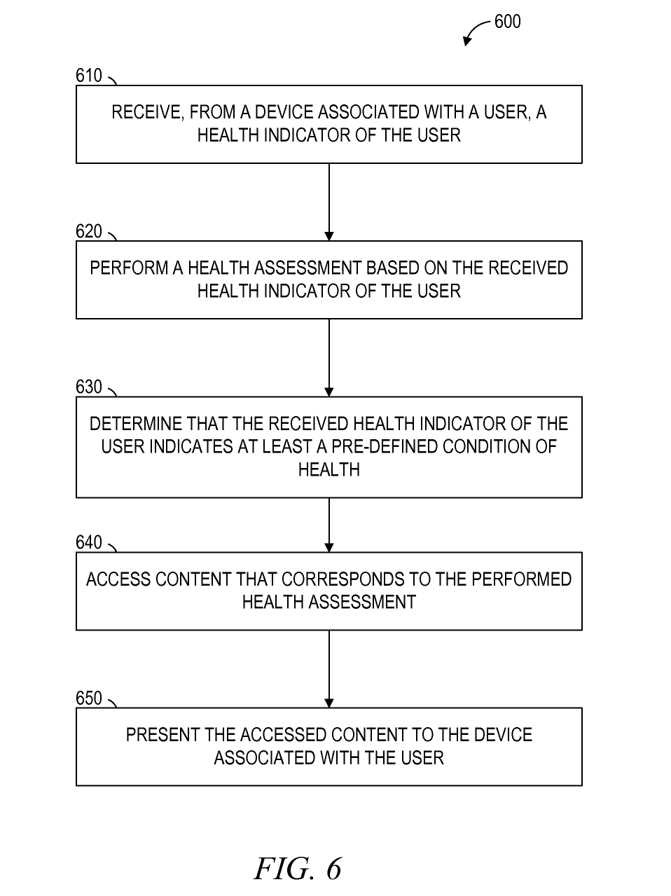

FIG. 6-8 are flowcharts illustrating operations of the server machine 110 in performing a method 600 of presenting content that corresponds to a health assessment to a device associated with a user, according to some example embodiments. Operations in the method 600 may be performed by the server machine 110, using modules described above with respect to FIG. 2. As shown in FIG. 6, the method 600 includes operations 610, 620, 630, 640, and 650.

At operation 610, the reception module 210 may receive a health indicator of a user. The health indicator may be received from a device associated with the user. The health indicator provides information regarding a health of the user. For instance, the health indicator may describe certain health conditions exhibited by the user. In some instances, the health indicator of the user may be a value or metric used to indicate the health of the user.

At operation 620, the health assessment module 220 may perform a health assessment based on the health indicator received at the reception module 210. The health assessment may identify specific health characteristics that are attributable to the user. Moreover, the health assessment may correspond to the health indicator of the user.

At operation 630, the health assessment module 220 may determine that the received health indicator of the user indicates at least the pre-defined condition of health.

At operation 640, the access module 230 may access content that corresponds to the health assessment performed by the health assessment module 220. In some instances, the content may correspond to the health assessment and may include information that is related to the health assessment performed by the health assessment module 220. In various example embodiments, the access module 230 is able to access the content once the health assessment module 220 determines that the received health indicator of the user indicates at least the pre-defined condition of health.

At operation 650, the presentation module 240 may present the accessed content to the device associated with the user.

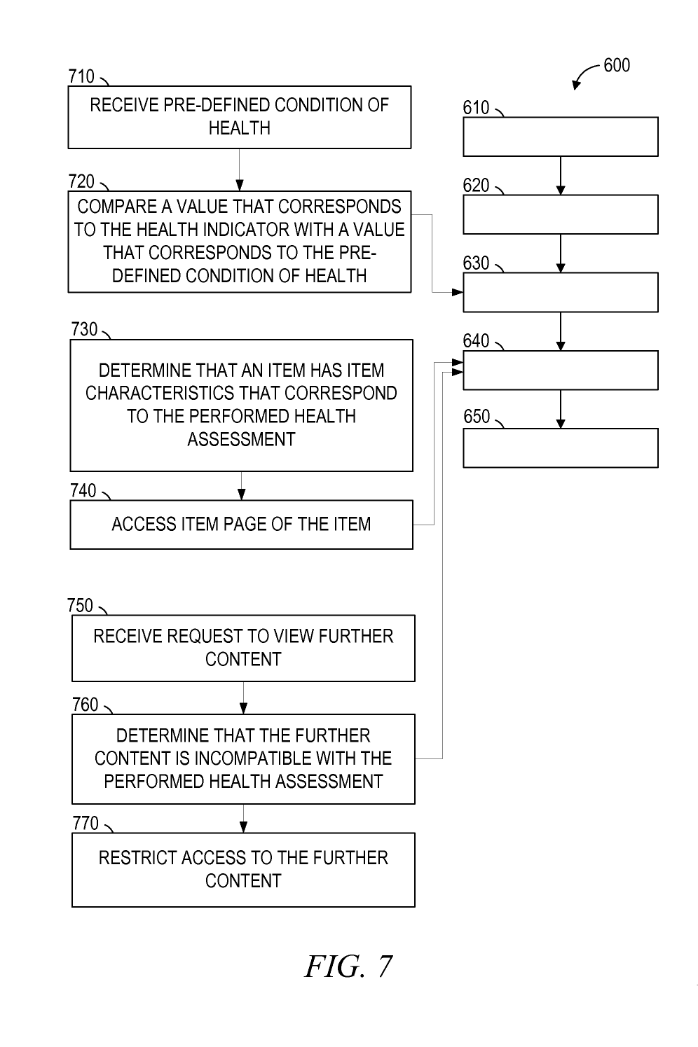

As shown in FIG. 7, the method 600 may include one or more of operations 710, 720, 730, 740, 750, 760, and 770.

At operation 710, the reception module 210 may receive a pre-defined condition of health. The pre-defined condition of health may prescribe certain health conditions that are required by the user before allowing access to view the content. In some instances, the pre-defined condition of health may be represented as a value.

At operation 720, the health assessment module 220 may compare a value that corresponds to the health indicator with a value that corresponds to the pre-defined condition of health.

At operation 730, the access module 230 may determine that an item has item characteristics that correspond to the performed health assessment. As stated previously, the health assessment of the user may identify specific health characteristics that are attributable to the user. Moreover, the access module 230 may determine that the item characteristics of the item match with the specific health characteristics attributable to the user.

At operation 740, the access module 230 may access the item page of the item that has item characteristics that correspond to the performed health assessment. The item page may include a description of the item, a picture of the item, a control operable to purchase the item, and the like.

At operation 750, the reception module 210 may receive a request to view further content.

At operation 760, the access module 230 may determine that further content is incompatible with the performed health assessment. The further content may include information that is dangerous or unsafe to a user's health.

At operation 770, the access module 230 may restrict access to the further content. For instance, the access module 230 may censor the further content so that the user is unable to view the further content on the device.

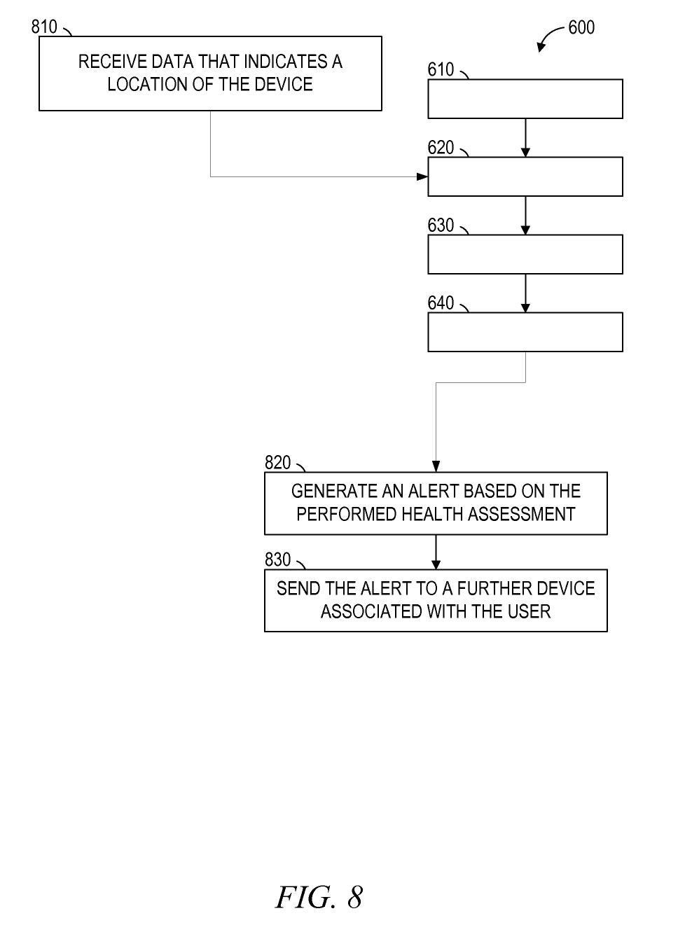

As shown in FIG. 8, the method 600 may include one or more of operations 810, 820, and 830.

At operation 810, the reception module 210 may receive data that indicates a location of the device. The data that indicates the location of the device may include GPS coordinates, an address, or any other information capable of identifying the location of the device.

At operation 820, the generation module 250 may generate an alert based on the performed health assessment. The alert may be used to provide for the safety of the user. For example, the alert may be used to indicate that the user is intoxicated.

At operation 830, the presentation module 240 may send the alert to a further device associated with the user. The alert may be used to disable functionality of the further device associated with the user.

According to various example embodiments, one or more of the methodologies described herein may facilitate accessing content based on a health assessment.

FIG. 9 is a block diagram illustrating components of a machine 900, according to some example embodiments, able to read instructions 924 from a machine-readable medium 922 (e.g., a non-transitory machine-readable medium, a machine-readable storage medium, a computer-readable storage medium, or any suitable combination thereof) and perform any one or more of the methodologies discussed herein, in whole or in part. Specifically, FIG. 9 shows the machine 900 in the example form of a computer system (e.g., a computer) within which the instructions 924 (e.g., software, a program, an application, an applet, an app, or other executable code) for causing the machine 900 to perform any one or more of the methodologies discussed herein may be executed, in whole or in part.

In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a distributed (e.g., peer-to-peer) network environment. The machine 900 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include any collection of machines that individually or jointly execute the instructions 924 to perform all or part of any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more modules (e.g., software modules) described herein.

The machine 900 may further include a graphics display 910 (e.g., a plasma display panel (PDP), a light emitting diode (LED) display, a liquid crystal display (LCD), a projector, a cathode ray tube (CRT), or any other display capable of displaying graphics or video). The machine 900 may also include an alphanumeric input device 912 (e.g., a keyboard or keypad), a cursor control device 914 (e.g., a mouse, a touchpad, a trackball, a joystick, a motion sensor, an eye tracking device, or other pointing instrument), a storage unit 916, an audio generation device 918 (e.g., a sound card, an amplifier, a speaker, a headphone jack, or any suitable combination thereof), and a network interface device 920.

The storage unit 916 includes the machine-readable medium 922 (e.g., a tangible and non-transitory machine-readable storage medium) on which are stored the instructions 924 embodying any one or more of the methodologies or functions described herein. The instructions 924 may also reside, completely or at least partially, within the main memory 904, within the processor 902 (e.g., within the processor's cache memory), or both, before or during execution thereof by the machine 900. Accordingly, the main memory 904 and the processor 902 may be considered machine-readable media (e.g., tangible and non-transitory machine-readable media). The instructions 924 may be transmitted or received over the network 190 via the network interface device 920. For example, the network interface device 920 may communicate the instructions 924 using any one or more transfer protocols (e.g., hypertext transfer protocol (HTTP)).

In some example embodiments, the machine 900 may be a portable computing device, such as a smart phone or tablet computer, and have one or more additional input components 930 (e.g., sensors or gauges). Examples of such input components 930 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 924 for execution by the machine 900, such that the instructions 924, when executed by one or more processors of the machine 900 (e.g., processor 902), cause the machine 900 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving, from a device associated with a user, a health indicator of the user;
performing a health assessment based on the received health indicator of the user;
determining that the received health indicator of the user indicates at least a pre-defined condition of health;
accessing, using one or more processors, content that corresponds to the performed health assessment; and
presenting the accessed content to the device associated with the user.

2. The method of claim 1, wherein the determining that the received health indicator of the user indicates at least a pre-defined condition of health includes:
comparing a value that corresponds to the health indicator with a value that corresponds to the pre-defined condition of health.

3. The method of claim 1, further comprising:
receiving the pre-defined condition of health from the device associated with the user.

4. The method of claim 1, wherein the accessing the content that corresponds to the performed health assessment includes:
determining that an item has item characteristics that correspond to the performed health assessment; and
accessing an item page of the item that has the item characteristics that correspond to the performed health assessment.

5. The method of claim 1, further comprising:
receiving a request to view further content, the request received from the device associated with the user;
determining that further content is incompatible with the performed health assessment; and
restricting access to the further content based on the determining that the further content is incompatible with the performed health assessment.

6. The method of claim 5, wherein the content and the further content are both featured on a single web page.

7. The method of claim 1, wherein the accessed content that corresponds to the performed health assessment includes web pages that are frequently browsed by the user.

8. The method of claim 1, wherein the accessed content includes a reward that corresponds to the performed health assessment.

9. The method of claim 1, further comprising:
receiving, from the device associated with the user, data that indicates a location of the device, and wherein the performing the health assessment is further based on the data that indicates the location of the device.

10. The method of claim 1, further comprising:
generating an alert based on the performed health assessment; and
sending the generated alert to a further device associated with the user.

11. The method of claim 1, wherein the health indicator includes at least one of: body temperature, heart rate, blood sugar, blood alcohol content, blood pressure, level of anxiety, volume of sweat, weight, or amount of sleep.

12. The method of claim 1, further comprising:
receiving, from the device associated with the user, a request to view the content, and wherein the accessing the content is performed in response to receipt of the request.

13. The method of claim 1, wherein the device associated with the user is physically coupled to the user.

14. A system comprising:
a reception module configured to receive, from a device associated with a user, a health indicator of the user;
a health assessment module configured to:
perform a health assessment based on the received health indicator of the user; and
determine that the received health indicator of the user indicates at least a pre-defined condition of health;
a processor implemented access module configured to access content that corresponds to the performed health assessment; and
a presentation module configured to present the accessed content to the device associated with the user.

15. The system of claim 14, wherein the health assessment module is further configured to compare a value that corresponds to the health indicator with a value that corresponds to the pre-defined condition of health.

16. The system of claim 15, wherein the reception module is further configured to receive the pre-defined condition of health from the device associated with the user.

17. The system of claim 14, wherein the access module is further configured to:
determine that an item has item characteristics that correspond to the performed health assessment; and
access an item page of the item that has the item characteristics that correspond to the performed health assessment.

18. The system of claim 14, wherein the reception module is further configured to receive a request to view further content, the request received from the device associated with the user, and wherein the access module is further configured to:
determine that further content is incompatible with the performed health assessment; and
restrict access to the further content based on the determining that the further content is incompatible with the performed health assessment.

19. The system of claim 18, wherein the content and the further content are both featured on a single web page.

20. A non-transitory machine-readable medium storing instructions that, when executed by one or more processors of a machine, cause the machine to perform operations comprising:
receiving, from a device associated with a user, a health indicator of the user;
performing a health assessment based on the received health indicator of the user;
determining that the received health indicator of the user indicates at least a pre-defined condition of health;
accessing content that corresponds to the performed health assessment; and
presenting the accessed content to the device associated with the user.
